(19) United States
(12) Patent Application Publication
(10) Pub. No.: US 2002/0124090 A1
(43) Pub. Date: Sep. 5, 2002

(54) Method and apparatus for data communication between a plurality of parties

(76) Inventors: Skye M. Poier, Vancouver (CA); Gresham Meharg, Vancouver (CA); Alexandre Pankratov, Burnaby (CA)

Correspondence Address: CAHN & SAMUELS LLP, 2000 P STREET NW, SUITE 200, WASHINGTON, DC, 20036, US

(21) Appl. No.: 09/932,461

(22) Filed: Aug. 20, 2001

Related U.S. Application Data
(63) Continuation-in-part of application No. 09/640,795, filed on Aug. 18, 2000.

(51) Int. Cl. G06F 15/16

(52) U.S. Cl. 709/228; 709/229

(57) ABSTRACT

A system and method to enable the secure transfer of information between nodes in a workgroup over a public network by facilitating the creation of a virtual private network (VPN). The system preferably includes at least a pair of nodes and a VPN server. The system preferably is centrally managed such that when an attribute relating to a node or server is revised, the configuration information related to that attributed is updated at each node within the VPN. The system further preferably includes a datastore linked to the server and a client application located at each node.

This application is a continuation-in-part of U.S. application Ser. No. 09/640,795 filed on Aug. 18, 2000, which is hereby incorporated by reference.

### I. FIELD OF THE INVENTION

The present invention relates to a system and method of providing secure communications over an open network, and more specifically to establishing a virtual private network (VPN), which runs across a diverse set of operating systems and hardware platforms and facilitates ease of use.

### II. BACKGROUND

Workgroup computing involves, by definition, the exchange of data between the nodes of the workgroup, a node being a computer connected to a network which can be identified with an individual, a set of resources (files, services, devices, etc), or a gateway. Often, the tasks of a workgroup are of a sensitive nature containing, for instance, confidential data on finances, business development plans, or private email. The Internet (and its native IP protocol) has become ubiquitous as a means of connecting nodes in a workgroup computing environment. However, with the adoption of the Internet and its public networking infrastructure comes the risk that an unauthorised 3^{rd} party with access to the data route between two nodes may intercept and reconstruct data transferred between them. To prevent interception, a mechanism is required to modify the transmission of data such that only the intended receiver may interpret it and the receiver can be guaranteed of the data origin and integrity.

A virtual private network is a logical entity consisting of multiple nodes having a secure communications over an open and typically insecure network such as the Internet. Data security is commonly achieved through the use of cryptography, which requires the data traffic to be encrypted at the sender's end and then decrypted at the receiver's end so that other users of the public network can intercept the data traffic, but cannot read it due to the encryption. Data encryption also allows the receiver to verify the integrity of the data received and therefore detect 3^{rd} party data tampering.

A typical VPN connects one or more private networks together through the Internet. Generally, the network on either side of the Internet has a gateway and a single-access connection to the Internet. To create the VPN, a secure communications path between the two gateways is formed such that the two private networks may communicate with one another.

In order to establish secure communication between any two nodes on a VPN, each node obtains by some means information (“configuration”) including but not limited to:

The identity and state of the remote nodes within the VPN

The relationships between nodes (VPN topology)

Cryptography for authentication and data communications encryption between nodes, for example the key for a VPN based on shared secrets or certified public key for VPN utilizing Public Key Infrastructure (PKI).

Secured communication between two nodes is commonly called a ‘tunnel’, while nodes themselves are often referred to as ‘tunnel terminators’. Traditional VPN solutions are comprised of a number of tunnel termination devices, which provide a central “hub” for VPN communication. Software is then deployed to nodes that wish to participate in a VPN, and the software is configured manually with the address of the VPN device(s). The software is then executed in order to participate in the VPN. However, there are several disadvantages with respect to this technology. In general, a VPN does not allow for automatic configuration of nodes for VPN participation as nodes change their network addresses on being dynamically added/removed to/from a VPN. In addition, each of the nodes may only be a member of one VPN at a time in the majority of implementations, which limits the ultimate efficiency of the user at each node

The use of VPN's is well known in the computer world each using different mechanisms to provide a means of secure data transmission. U.S. Pat. No. 6,061,796 entitled “Multi-Access” Virtual Private Network describes system and method for allowing private communication over an open network. This system however, specifies what mechanism protocol level the Agent (VPN provisioning application) uses to intercept incoming and outgoing data from a node and is not designed to work with IP networks. In addition, it would be difficult to scale this particular system for large-scale use. In U.S. Pat. Nos. 5,884,035 and 6,026,430 data transmission is only through the domain hierarchy and not on a data to client application basis. In the VPN system described in U.S. Pat. No. 6,055,575 it notes that the “host computer establishes a secure communications path, referred to as a tunnel, through the public network with the remote client”. This has firewall implications in that a remote node can rarely accept incoming connections.

Another very common limitation of traditional VPNs is their inability to cross boundaries of private networks linked to each other through one or more Network Address Translation (NAT) devices. In addition, existing VPN do not facilitate the use of end-to-end security in the presence of firewalls, gateways, and proxy servers. NAT devices, both regular and PAT are very widely deployed to allow for better security by hiding details of private network from the outside world and to facilitate conservative use of public IP addresses by mapping multiple private addresses onto single public one. With the growth of the Internet and delayed introduction of version 6 of IP protocol (Ipv6), more and more companies will be forced to use NAT devices as IP address space available for general public becomes increasingly exhausted. The above-mentioned limitation arises because a NAT device modifies the data packet to allow for proper routing both inside a private LAN and in the outside world. However, any change to the packet is treated by tunnel terminators as a tampering, thus packets undergoing NAT processing are discarded as damaged.

As it follows from known PAT functioning principles, the presence of post-IP header is a necessary condition for the packet to be translated by the PAT. Also, since a PAT device maps all internal nodes onto a single IP address, it creates and maintains internal associations between IP address and post-IP header of the internal node and its translated post-IP header. This means that traffic traversing PAT device and destined for an internal node requires a proper association to be in place to facilitate the reverse mapping. In other words, any post-IP session between PAT'ed and external node may only be initiated by the external node.

It is an object of the present invention to obviate and mitigate at least some the aforementioned disadvantages of the prior art.

### III. SUMMARY OF THE INVENTION

Accordingly one aspect of the present invention provides a system for facilitating the secure communication between nodes in a workgroup by the creation of an “n”-tiered virtual private network (VPN). Each node preferably has the ability to transmit and receive secured data over a public network such as the Internet. The system comprises at least a pair of nodes, a server, a datastore linked to the server (where the datastore may be in the form of memory, a disk, a database etc), and a client application capable of communicating with the VPN server and securing IP-level connections towards other VPN nodes by utilizing a suite of protocols, for example and IPSec protocol, in particular an ESP protocol. The datastore further includes information pertaining to the configuration of VPNs, VPN relationships (e.g. client computer membership to VPN's), settings and options (e.g. IPSec ciphers to use), authentication information, and objects and attributes (e.g. status—online/offline, human-readable node description, node IP). The system further includes a means to intercept both incoming and outgoing data from a node so as to create a secure tunnel between an open network and a node by encrypting and decrypting data. In addition, the system includes a means for verification of node credentials against authentication servers. The tunnel enables data to be securely shared to VPN(s).

The present invention is designed to facilitate the aspects of VPN functionality including but not limited to: securing communication within the VPN and VPN configuration for the exchange of secure information between VPN nodes.

In another embodiment, on start up of a node within the system, the client forms a connection with the VPN server. Authentication credentials are transmitted to the VPN server, where they are validated and a connection is established. Following the creation of a secure connection between the VPN server and a node, the client application is synchronized with the VPN server by receiving and processing initial configuration information. This information includes a list of VPN's of which this particular node is a member, their respective attributes, a listing of other nodes which are members of the same VPNs as the client computer, the current status of each node in each respective VPN, and other related details. Once a node is logged onto and synchronized with the VPN server its client application sits in the loop so as to maintain the node in sync with the rest of the VPN by sending and receiving status and configuration updates to/from VPN server. The central management of the system enables the server to be informed of any changes to a VPN e.g. a node logging off, and is informed of these changes in a timely manner, where the time frame is elected by the node. The VPN server then relays this information to each node within the VPN, which in turn is putting its self, the VPN server, in sync with the system.

This system is global by the nature of the server such that it facilitates the central management of any VPN. The server facilitates the ability to make changes to a VPN without having to effect changes manually at each node of a virtual private network. A change made to the datastore linked to the server is transmitted in a timely manner to all client computers effected by the change. For example, to change the password of a VPN for each node in a network requires making that change to the datastore and, in turn, that change is transmitted to each node on the virtual private network. While changing a password is a relatively simple task, the ability to effect more detailed changes to a VPN requires updating only a single point in a VPN and then transmitting that data to the remaining nodes in the workgroup via the secure connection. In use, the network includes the ability to automatically and securely provision security associations between nodes.

The control of the VPN created using the VPN server may be in house in the sense that, at a particular company subscribing to this service, an IP manager would administer and maintain the VPN and have rights to modify information on the server and datastore as it pertains to their VPN. Generally, IP traffic between two nodes on a VPN is encrypted and decrypted regardless of the type of information being sent. The decision as to secure the channel between two nodes or not is made by VPN server based on the topology configuration of the VPN. The server itself however, does not participate in node-to-node data transfer.

This invention further provides a system to enable secure communication between nodes over the Internet and have the benefit of end to end security. This system enables a node, which may operate behind generic NAT box and/or a firewall, to establish and use secure communication over the Internet with another node. In general, there are two different types of Network Address Translation (NAT) devices—regular NAT and Network Port Address Translation. The difference between these two types is that a regular NAT device uses IP header information to relay packets to and from members of a private group. Network Address Port Translation uses an IP and transport layer protocol (TCP/UDP/ICMP) header. This is also referred to as PAT.

The system comprises at least a pair of nodes belonging to the same virtual private network, a packet interception mechanism, a secure line for communication to the VPN server, and a client application located at each node. The client application located at each node includes a mechanism to encrypt, decrypt or process data exchanged within the virtual private network, and a software module responsible for maintaining configuration information including VPN relationships, authentication information, and settings and options. In addition, the configuration information indicates the presence of a NAT device, firewall, gateway, and proxy server in front of particular nodes in a VPN. The system further comprises a mechanism for verification of node credentials against authentication servers, which enables data to be securely shared amongst members of a private group. The packet interception mechanism is generic and known to one skilled in the art.

Once nodes are logged onto a VPN, they may exchange information. Outgoing data packets are intercepted and then those destined to a specific VPN node are selected for further processing. When ongoing data packets are intercepted, the VPN indicates the presence of a NAT or PAT device, a firewall, gateway, and proxy server in front of the intended receiving node. In order to facilitate data exchange to nodes located behind one of the above-mentioned devices, the data packet header is modified. The data packet itself is encrypted as a whole and a new header is prepended to the now encrypted data packet. Source and destination node information is added to the prepended header and is determined by the VPN. The new header is referred to as an “external header” and the original packet header is referred to as the “internal header”. The external header contains a masquerade bit which allows the receiving node to recognize the modified data packet as having a prepended external header. Once the data packet traverses the device, the external header is removed and the packet is processed according to the specifics indicated by the original IP header.

### IV. BRIEF DESCRIPTION OF THE DRAWINGS

These and other features of the preferred embodiments of the invention will become more apparent in the following detailed description in which reference is made to the appended drawings wherein:

FIG. 1: is a schematic diagram of an overview of a computer system;

FIG. 2: is a functional block diagram detailing the method for establishing secure communication between nodes, in the computer system of FIG. 1;

FIG. 3: is a schematic of the computer system incorporating a plurality of types of nodes;

FIG. 4: is a schematic diagram of an overview of a computer system incorporating LAN's, a gateway, and a firewall;

FIG. 5: is a functional block diagram detailing the method for sending data over a VPN having secure communication in the computer system of FIG. 1;

FIG. 6: is a functional block diagram detailing the method for receiving data over a VPN having secure communication in the computer system of FIG. 1;

FIG. 7: is a schematic of the data packets transferred between a plurality of types of nodes on a VPN; and

FIG. 8: is a schematic diagram of an overview of another embodiment of the computer system of FIG. 1.

To facilitate the understanding of the preferred embodiments described below, the following terminology will be used, it being understood that this is for illustrative purposes only and is not limiting:

Client Application—the software that acts as a slave to a server and is present on each node within a work group;

VPN—a virtual private network that is constructed over a public network to connect nodes within a work group such that:

a) data transferred between those nodes is secure and cannot be intercepted, modified, or replaced on route; and

b) it contains mechanisms to ensure that only authorized users may access the network.

Node—a computer connected to a network which maybe identified with an individual, a set of resources, or gateway;

Work Group—a group of two or more individual nodes working collaboratively on a group of tasks;

Gateway—a special node that provides secure communication to a specific network of nodes located behind the gateway; and

Network Address Translation—(NAT) an Internet Standard that enables a LAN to use one set of IP addresses for internal traffic and a second set of addresses for external traffic.

### V. DETAILED DESCRIPTION OF THE EMBODIMENT

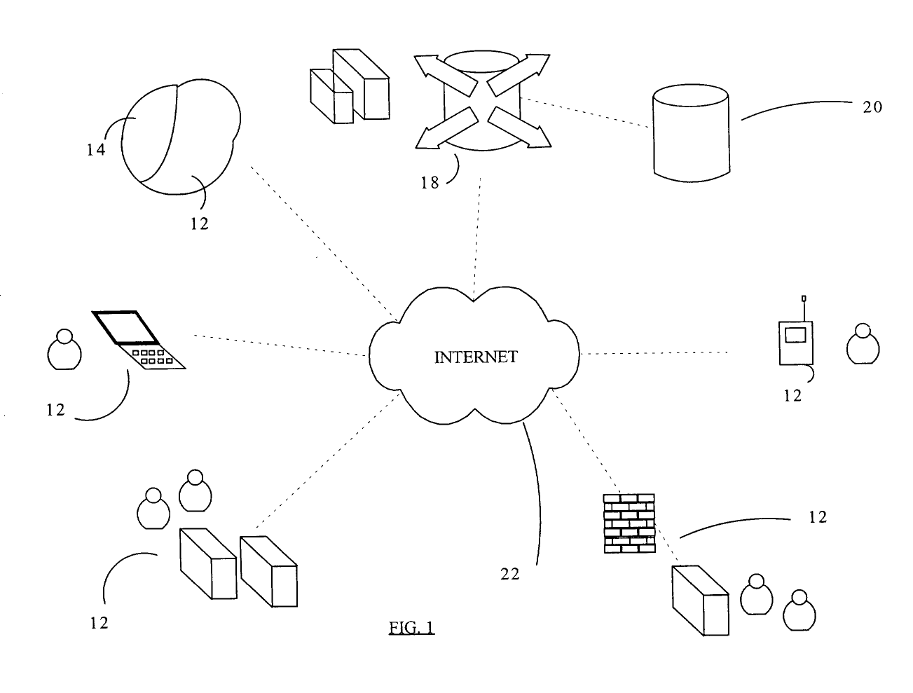

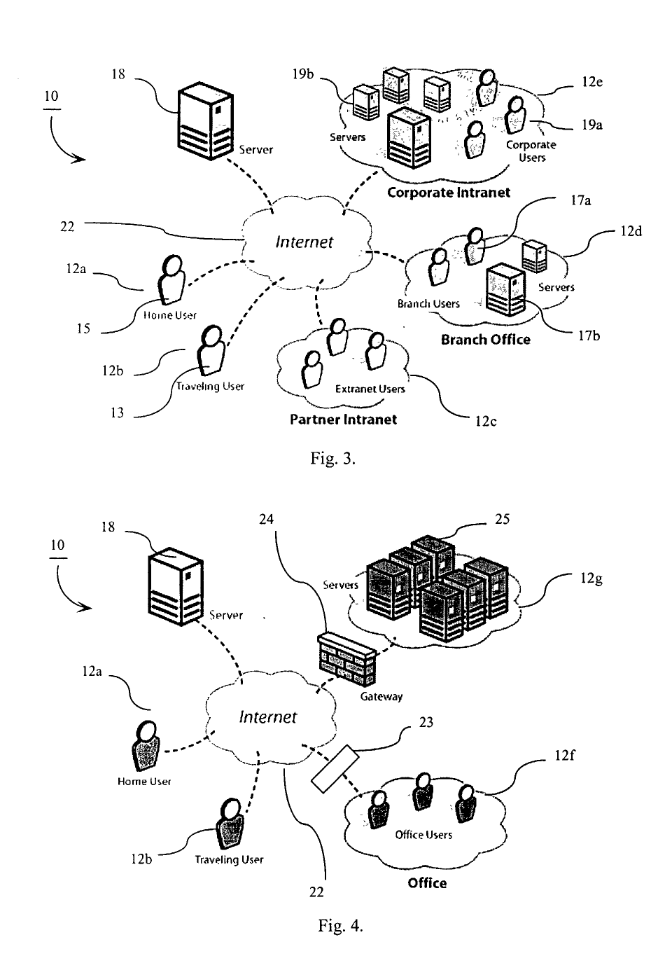

A system and method for establishing a secure connection for the transfer of data between nodes in a work group over a public network is illustrated in FIGS. 1 through 8. The computer system is generally designated by reference numeral 10. The system 10 may be configured in a number of different ways including those utilizing individual users as shown in FIG. 1, those utilizing individuals and intranet as shown in FIG. 3, and those utilizing a gateway as shown in FIG. 4. Initially it is necessary to establish communication between members of virtual private network (VPN) and this procedure will be described in respect of each configuration.

As shown in FIG. 1, a computer system 10 comprises a plurality of nodes 12 (client computers), server 18, and a datastore 20 whose contents may be updated or changed periodically by external intervention. Server 18 is also referred to as the VPN server however, it is understood that the VPN server is capable of performing typical server functions known in the art in addition to the provisioning of a VPN as is described below. Each of the nodes 12 includes a client application 14 capable of communicating with server 18. The system 10 is arranged to enable the establishment of a secure path for communication between nodes 12 over a public network such as the Internet 22. The server 18 collects and distributes data collected by the client application 14 at each node 12, so as to maintain state information for each node 12. The server 18 tracks changes made to the datastore 20 and subsequently updates each of the nodes 12. The client application 14 is responsible for transmitting information to and receiving information from a second client application 14 of a node 12 and server 18. The server 18 also serves to generate specific node cues based on those events, such as the availability of upgrades for client application. The datastore 20 is linked to the server 18, and is managed so as to enable the automatic provisioning of security relationships with nodes 12 in a network. A network having secure communication between these nodes 12 is typically known as and from herein referred to “a virtual private network” (VPN). The centrally managed system 10 allows for arbitrary additions, modifications, and alterations to the datastore 20 and, in turn, deploys that information through the server 18, to nodes 12 located within a virtual private network.

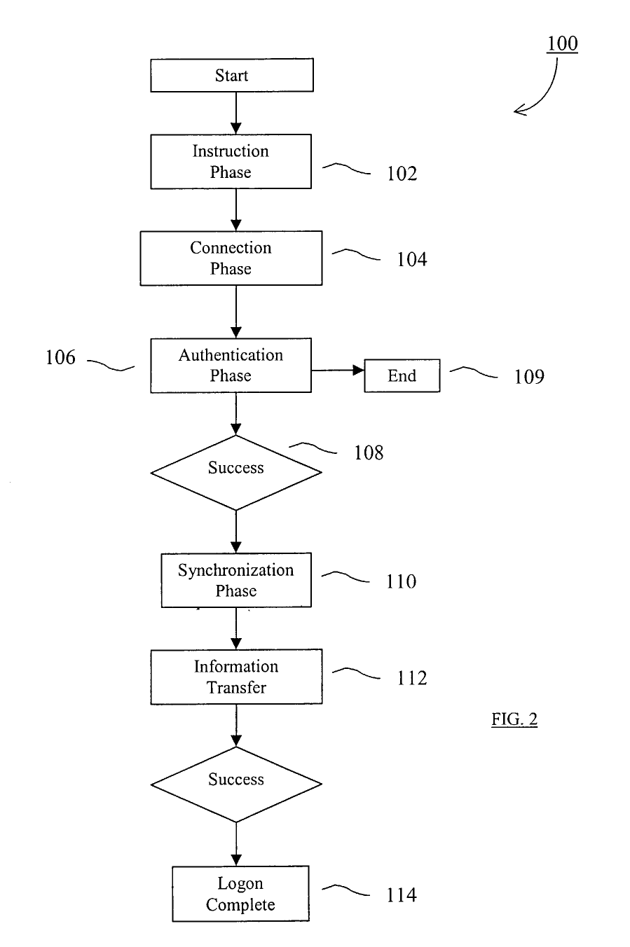

The method of establishing secure communication between nodes in a work group is detailed in FIG. 2. On startup of a node within a work group, the client application 14 instructs the node 12 to form a connection with the server 18. Once the instructions have been received, as indicated at 102, a socket connection is formed between that same node 12 and server 18 (generally using secure socket links such as SSL/3DES socket security). Once the connection, 104, is formed between the server and the node, the authentication phase, 106, begins. The client application transmits credentials to the server 18. The server 18 then authenticates the validity of these credentials and returns data stating the success 108 or failure 109 of the logon to the server. If the credentials are found to be invalid the process fails and ends. Once the node is logged onto the server 18 and a secure connection is formed, the synchronization phase 110 begins. The server 18 delivers a packet of configurational information to the client application 14 of a node 12 via the secure socket connection so as to establish a virtual private network. The configurational information includes, but is not limited to, a list of virtual private networks to which that node is a member, their related attributes, the state of other nodes located within a VPN of which the node or client computer is a member, and their related details such as IP address. Once this transfer of information 112 has occurred, the server 18 and node 12 are successfully linked as indicated at 114, and the ability to transfer data over a secure line of communication is enabled. Once a node is logged onto the server 18, data is transferred between a pair of nodes 12 by invoking procedures on remotely hosted applications on the node 12 and determining the type and target of the change or data to be distributed.

The system 10 is global by nature such that it facilitates the central management of the VPN. The system 10 enables each node 12 and server 18 to be informed of any change to the VPN by updating a single point within the VPN and transmitting that data to all affected members of the VPN. Once a node is logged on to a VPN, thereafter, any change to the datastore 20 that affects a work group of which the node 12 is a member will be forwarded from the server 18 to that node. The server is able to determine the relevant nodes 12 from the contents of the data product received during the information transfer phase 112. There are two types of changes that affect the datastore 20. A node generated change e.g./going offline, invokes an application located on the server 18 to change the attribute of “itself”. The server 18 examines the type of change, in this case—going offline, and determines all online nodes in the VPN's that the node is a member of which require notification. The server 18 retrieves a list of those nodes from the datastore 20, and notifies each interested node. The notification is either synchronous or asynchronous.

A management interface change e.g./altering VPN membership for example, through a web-based configuration tool, invokes a procedure on the server 18 notifying the server 18 of the change to the datastore 20. The server 18 examines the type of change and distributes the notification as described above. Accordingly, a VPN is established to allow communication between each of the nodes. A similar procedure may be utilized in the configuration of FIG. 3.

FIG. 3 illustrates a plurality of nodes 12A through 12E, where at nodes 12C through 12E there are a plurality of client computers. The computer system 10 detailed in FIG. 3 is a multi-tiered client/server system in which every node 12 acts as both a client and server. A node either pulls update from the server, and in such a case in synchronous or acts as a client, or the server pushes updates to a node by invoking a method on an object which resides on the node, hence is asynchronous and acts as a server. The server 18 operates over an existing network connection to the Internet 22 that each node 12 possesses. The computer system 10 allows arbitrary grouping of nodes 12 on the Internet 22 into VPNs across, for instance, network, organisational and geographical boundaries.

The computer system 10 enables an extranet connection for example between two offices of a company 12D and 12E, each of which includes its own Intranet, to be included in a work group. In this situation a corporation typically will have at least one localized server 17B, 19B, which will act as server for that Intranet. Each node 12 within that corporation will be connected to that localized server. The localized server 17B, 19B exists within a hierarchy within the computer system such that if a node/client computer within the corporation queries the localized server, and that server does not contain the information queried for, that server climbs the hierarchy chain to a higher up server and queries for the information. This process continues until the information is returned to the localized server where it can be distributed to the appropriate client computers within that network. Alternatively, a node within the corporate network is capable of communicating with, for example a traveling user 12B located outside the office.

When each node 12A through 12E logs onto the server 18, such that each node in the network exists in a parallel relationship with another node. In one embodiment, each pair of nodes is typically setup with a set of keys and a unique identity such that they may transmit secure messages that have been encrypted and decrypted using this set of pair based keys. Preferably, the system 10 employs an existing peer-to-peer key exchange mechanism e.g. Internet Key Exchange (IKE), to negotiate session keys with each peer for data exchange. However, in the event that IKE is inaccessible, a pair of nodes 12 may negotiate and transmit keys via server 18. In the alternative, the server 18 may generate and distribute to keys and node pairs 12. It will be appreciated that when transmitting data between two nodes logged on to a virtual private network, that data is not transmitted through the server 18. The server 18 is used for the initial provisioning of the virtual private network and to transfer information to the client application 14 of each node 12 with configuration information for the provisioning of that virtual private network. Again a VPN is established between a set of nodes interconnected by the Internet 22.

FIG. 4 again shows computer system 10, and in this embodiment, involves the use of a gateway 24 that includes a library portion containing attributes of the servers connected to the gateway 24. Although the gateway 24 controls access to several nodes, each indicated as a server 25, the gateway 24 is considered a node by other users within the VPN and typically includes a key pair associating it with each of the other nodes in the system 10. During the logon process detailed in FIG. 2, the server 18 will detect the presence of the gateway 24 and, during the synchronization phase, the datastore 20 will provide information to the gateway 24 as to the range of IP addresses that are assigned to nodes behind the gateway. In an alternative embodiment, the server will also detect the presence of a firewall 23 (shown in FIG. 4), NAT box, or PAT box (not shown) as above. The gateway 24 includes a set of rules called security associations that are designed to control access to the VPN such that the gateway protects a plurality of nodes. Conventionally, when a node in front of the gateway, such as 12A wishes to communicate with a node behind the gateway such as 12G, the node 12A selects the key pair associated with the gateway 24 to provide encryption and decryption of the data. The decryption then occurs at the gateway as opposed to at the node to which the message is directed. The same is true of a NAT device where decryption traditionally occurs at the device. When a user who is typically a member of the plurality of nodes located behind the gateway, such as a company network 12G, is working from home 12A, the IP address of the home computer 12A is not in the range of IP addresses specified by the gateway 24. When an IP address falls outside the range of addresses known to the gateway 24 access may be denied to the company network. In such a situation, a virtual IP (VIP) address is typically assigned to the home user 12A. When a VIP is assigned to the node of the home user 12A, data sent from node 12A to the company network 12G, located behind the gateway 24, the gateway will route this data through a virtual interface. In the case where a node is a intranet, as in FIG. 3 node 12C, and that node 12C wants to send data to 19B, the server 18 will have a plurality of rules known as an access control list (ACL), stating which client computers located within 12C may access data on the servers. Security measures in each of the above cases conventionally are employed at the gateway 24.

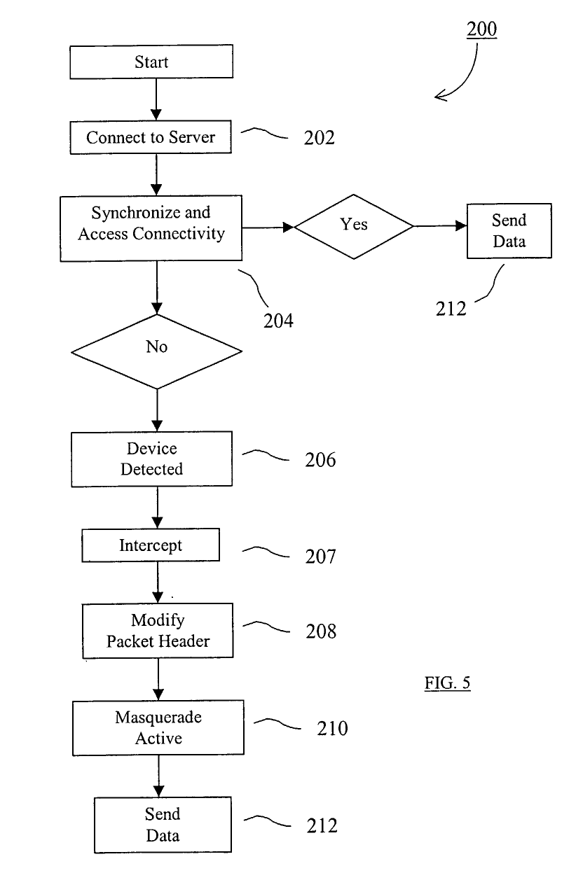

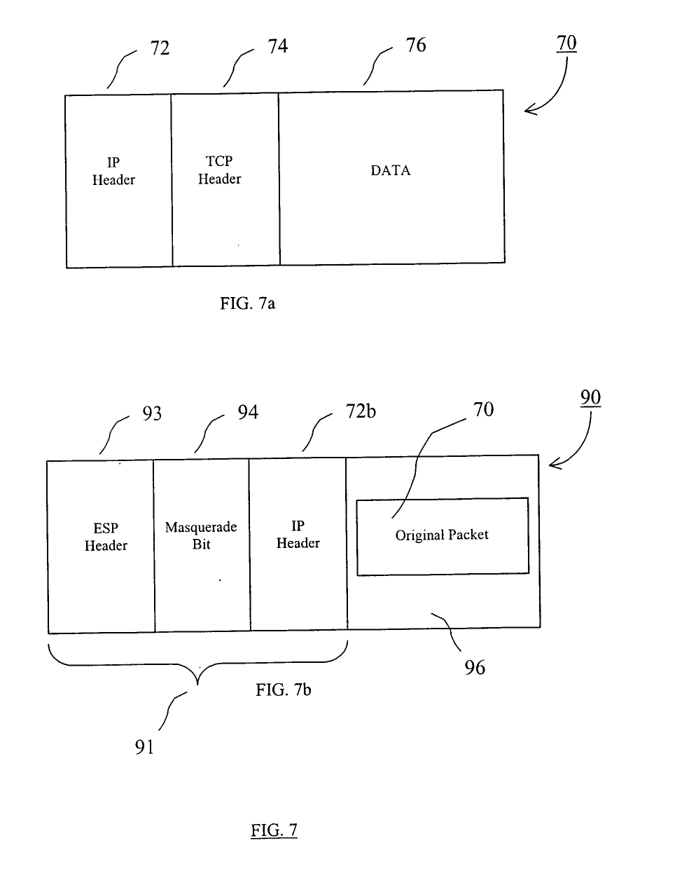

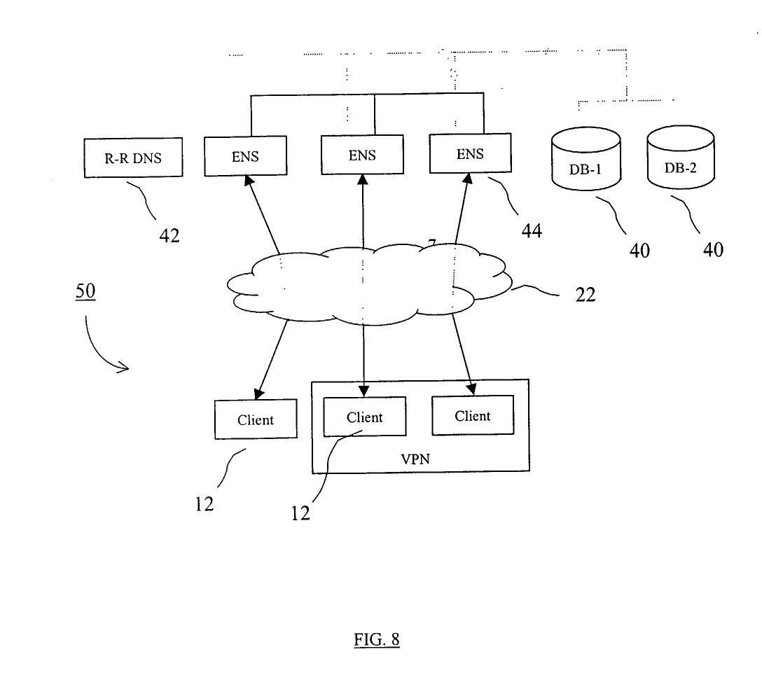

In order to employ end to end security in the presence of firewalls, gateways, NAT/PAT boxes, and proxy servers or when connections are slow and unreliable, a preferred procedure is set forth in FIG. 5 is utilized. On startup of a node 12 within a work group (as shown in FIGS. 3 and 4), that node forms a secure connection with server 18, as described in FIG. 2. Once connected to the server, 202, on synchronization a mechanism assesses connectivity between nodes and determines the presence of NAT devices, firewalls, gateways and proxy servers in front of particular nodes within the VPN. On assessing connectivity, 204, where a node is located behind for example, a NAT or PAT box, that configurational information is conveyed to the client application of each member within the VPN. Provided a node is not located behind a gateway, NAT/PAT box, firewall, or proxy server, a data packet, originating from independent applications, is sent securely from one node 12 to another typically employing conventional methods of end-to-end security. Such packets typically comprise an IP header 72, a TCP header 74, and data 76 as shown in FIG. 7a. The IP header communicates the data endpoint, the TCP header specifies the transport protocol, and the data portion is the bit stream which comprises the message being sent. The actual processing of the information contained within the data packets, as well as the decryption, is known in the art and falls outside the scope of this invention.

In the event that a device is detected in front of a particular node, the system 10 employs a modified method of communication that facilitates end-to-end security and is described below. The detection of a NAT device, firewall, gateway, and proxy server, 206, indicates to the system 10 to invoke a modification to the data packet in order to facilitate traversing of the device. Data packets, originating from a node within the VPN are intercepted, 207 and those packets destined to a specific VPN node located behind a device are selected for further processing. The selection for further processing informs the system 10 that these data packets that have been intercepted require modification in order to enable their sending. Thus, the data packets are examined and packet headers are modified 208 (as shown in FIG. 7) as will be described below. This masques the data packets such that, to the device they appear to be unmodified and traverse the device as secure encrypted data packets. The masqueraded data packets preserve the original data packet and header information as an encapsulated secure payload and appends a new external header. The external header includes a data bit from herein referred to as a “masquerade bit” which acts as a “flag” or “indicator” that the packet header has been modified, 210. To the device, such as those shown in FIGS. 3 and 4, the data packet appears to be an unmodified protocol session and passes through the device unread. In the case of a firewall, (shown in FIG. 4) upon receipt at the firewall, the external header is identified as an SSL and is directed to dedicated port 443 in the wall and passes through that port without further examination to the intended receiver.

In the preferred embodiment, the system nodes are restricted to use Encapsulated Security Payload (ESP) protocol in tunneling for securing data being exchanged by VPN nodes. This is a protocol that resides on top of the IP layer in network stack and thus allows for securing any IP traffic. A data packet secured by Tunneled ESP is encrypted as a whole, and is prepended with an ESP header and another copy of IP header which comprises a new external header. Source/destination node information in the new IP header within the external header may differ from the IP header in original data packet. The ESP processing setup determines any change to the IP header information. Original IP header is further referred as ‘internal’ and newly prepended one—as ‘external’.

Typically, when an encrypted packet traverses a NAT device, for example, its external IP header is modified to contain proper addressing information. Upon arrival at the destination node the external IP header is stripped off during data processing and the external IP addressing information is irrevocably lost. Therefore, the receiving node is not able to process the decrypted packet properly. In the present invention, the data packet memorizing the external IP header prior to its stripping, and then adjusts internal IP header based on the network setup. For example, a data packet when traversing a NAT device, arrives at the NAT device and at this point prompts the system to copy the destination IP address from the external header. If, in addition, the data packet arrives from a NAT'ed node (a node having a NAT device in front), then the system is further prompted to update the source IP address from the external header. The IP/TCP/UDP checksums of the adjusted packet are recalculated or turned off such that the packet integrity is guaranteed by successful decryption. The centralized nature of the VPN supplies nodes with information about their peers that allows for each node to decide if a particular peer or node is NAT'ed. This effectively eliminates the ‘detection’ (or ‘negotiation’) step known by those skilled in the art and typically employed by other NAT-traversal methods to determine the presence of the NAT between two nodes. The process described above of changing the IP header before submitting a data packet to the IP processing is further referred to as ‘RNAT transformation’.

A data packet traversing a PAT has both its IP header modified as well as its transport layer header translated. Commonly supported transport protocols are TCP and UDP. ICMP, while not being true transport protocol, is also generally provided a limited support for its ECHO messages. Note that these three protocols are referred as ‘post-IP protocols’ below.

In the case where a data packet traverses a PAT device, the system employs the following approach. Assume node A being PAT'ed node (a node having a PAT device located in front) and node B its peer residing outside the PAT device. In this case, node B may be located behind NAT, but not PAT device. A packet sent by node A is processed as described and above and then in turn, receives a UDP header and a masquerade bit inserted between IP and ESP headers of the encrypted packet as was described above. This extra step of outbound processing, including the UDP header, is further referred as ‘UDP-masquerading’ or ‘masquerading’. The masquerade allows recipient to differentiate between masqueraded and ‘true’ UDP packets with a high degree of accuracy. Upon arrival of a data packet at node B having traversed a PAT device, the data packet UDP header is associated with the tunnel through which it arrived. In other words, it associates the node from which the data packet originated. Then packet is then stripped of the UDP masquerade header to reveal the original header and inbound ESP processing and RNAT transformation is performed as previously outlined. The ESP code links plain text post-IP information to the tunnel through which it was delivered.

A data packet leaving node B destined for node A is first subject to a regular ESP processing with compulsory Tunnel selection based on its IP and post-IP information stored during inbound processing. Once encryption of the data packet is completed, the data packet is masqueraded based on masquerading information also stored during inbound processing. Upon arrival at node A, the data packet is subject to demasquerading, regular ESP processing and RNAT transformation.

In a further embodiment, the system facilitates a means to potential post-IP information ambiguity developing on node B after packet decryption. For example, two nodes (A1, A2) may reside behind the same PAT device and use the same source port to access the same node B port. It this case, after RNAT is applied, data packets originating from nodes A1 and A2 are indistinguishable and a reply from node B could not be routed back to the appropriate node. The system in this case applies a post-IP layer overloading (similar to the PAT) to each data packet traversing the same PAT device arriving through different tunnels. A PAT transformation is applied to all inbound data packets to resolve ambiguities and the reverse mapping to the originating node is performed on the outbound data packet in order to restore the post-IP headers to peer's expectations.

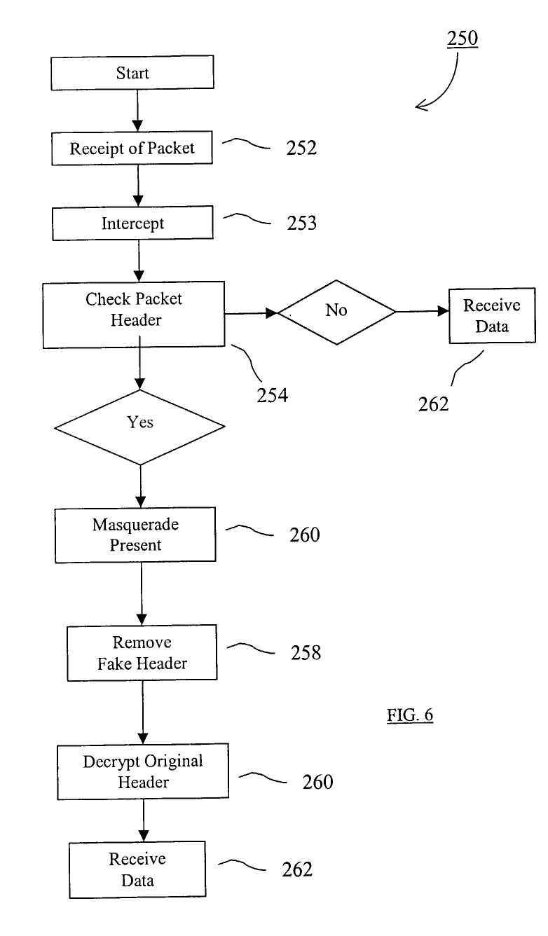

When a node is the intended recipient and that node logs on to the VPN, the node receives a data packet 252 as shown in FIG. 6. When a data packet arrives, the interception mechanism (253) analyses the packet header 254 for the presence of a masquerade bit. If a masquerade bit is not detected, the data packet is received by the intended node 262 and is processed. When a masquerade bit is detected 256, it indicates to the system that further processing is required. When the received node is located behind a NAT/PAT box, it is the box that receives the data packet, analyzes the header, and detects the presence of a masquerade bit. In the case where there is no NAT/PAT box, the node performs the analysis and detects the masquerade bit. Once the masquerade bit is found, the external header is removed 258 to reveal to original header. This original header is examined and the packet is routed to the intended-receiving node and allows for return data to be sent.

If, in the above circumstance, the node is not logged on to a VPN, the packet is sent and once the peer or intended receiving node logs on to a VPN the packet is received by the peer following the procedure outlined in FIG. 6.

FIG. 7 shows the transformation of a regular data packet 70 illustrated in FIG. 7a to a modified data packet 90 illustrated in FIG. 7b that was described in FIG. 7. The originating data packet 70 includes an IP header 72, a TCP header 74, and a data portion 76. In order to facilitate end-to-end security in the presence of a firewall, NAT/PAT box or gateway etc, the data packet is modified/re-written, as described in FIGS. 5 and 6. The modified data packet 90 comprises a new header 91 and a data payload 96. The header 91 of the modified packet 90 comprises an IP header 72b, and ESP header 93 and a masquerade bit 94. The data payload 96 of the modified pack 90 encapsulates the original data packet 70. On receiving a modified packet, as detailed in FIG. 6, the new header 91 is removed and the packet is processed to reveal the original data packet 70.

On securing a communications path over a public network between two nodes in a computer work group, a typical encryption technique used to transfer data between these nodes includes: generating a data packet to be transmitted over the secured communications path where the data packet includes routing information; encrypting that data packet using an encryption technique known to one skilled in the art; encapsulating the encrypted data packet into a secondary data packet compatible with public network protocols; transmitting the encapsulated data packet over the public network; the data packet arriving at the receiving node; and that receiving node unpacking the encrypted data packet using a set of authentication keys, stripping the second data packet from the original data packet, and decrypting that data packet received from the originating node.

In the preferred embodiment, secure IP communication using end-to-end security between any two nodes 12 over the Internet 22 is established with only minimal assumptions about any particular node's connectivity privileges. This is accomplished by applying IPSec transformations to incoming and outgoing IP packets at the transport layer and then transforming these processed packets so they appear to be an SSL protocol session until received by the destination node.

For operation within the system, the node (base configuration) preferably includes:

An IP address and a connection to the Internet (may be non-unique); and

Ability to send and receive TCP data on port 443 in SSL format (on some servers may also require the ability to send and receive TCP data in SSL format on a port specified by the server).

The optimal configuration for a node (recommended configuration) is defined as follows:

Those abilities defined in the base configuration; and

A globally routable IP address or 1:1 static NAT.

At least one node in each pair supports at least the recommended configuration, and the other node supports at least the minimum configuration. The system requires that only one of a pair of nodes may be located behind a firewall. The recommended encryption level for data in transit is 3DES. The system, in the preferred embodiment, accesses both:

configuration data (IP addresses, etc) provided by server, client application, and library aforementioned; and

a packet interception and injection mechanism partially provided by Trilogy AdmitOne

The computer system 10 may be run on a diverse set of operating systems and hardware platforms such as open BSD, UNIX, Windows NT, Windows 95/98, Linux, and Solaris.

In another embodiment, as shown in FIG. 8, a system 50 comprises VPN servers 44, which function as central policy management for establishing and facilitating VPN operation. The system 50 further comprises at least a pair of database servers 40 and a Round-Robin Domain Name Server (DNS) 42 in a distributed, fully integrated environment. The DNS server 42 assures homogenous distribution of the data load across the VPN servers 44. Connectivity between VPN servers 44 and the database servers 40 is implemented so as to support several modes of communication including but not limited to open database connectivity (ODBC), Java Database Connectivity (JDBC) or any other database connectivity interface. The database servers 40 are mutually synchronized to keep the data contents current and up-to-date. The content of each database server 40 is identical such that, should one database server 40 crash, each of the VPN servers 44 connected to that failed database server 40 may automatically reconnect to another available non-failed database server.

The VPN server 44 may operate in either a standalone or a distributed environment. The nodes 12 participating in a VPN may be connected to the same VPN server 44, as the VPN servers 44 are synchronized such that a node may log onto any VPN server 44 and participate in a VPN of which they are a member. As the system 50 is fully synchronized, forwarding from one VPN server 44 to another is not necessary. Each event or revised attribute of a node 12 or server 44 is distributed to the entire system 50 directly by the original sender. Synchronization enables VPN nodes to see one another as if they were physically connected to the same VPN server 44.

The system 50 employs a variety of communication protocols utilized within the VPN environment so as to facilitate communication of the VPN server 44 and its node 12 across the open network environment. In the preferred embodiment, communication within the system 50 occurs at a “secure sockets layer” (SSL) underneath any security attributes. The system however, further enables communication, in one embodiment at the application layer. Such communication may be in the form of the following:

a) Authentication of users

When a VPN node 12 is going online, the node 12 submits its authentication credentials, which are validated on the server side. The node 12 may enter another state of communication once the authentication credentials have been approved. The system 50 supports two ways of authentication, either using a user name and password or client side certificates however, authentication is not limited to these two types.

b) Proxy authentication of users

On authenticating the credentials of a node 12, the credential(s) is validated against an external data repository, for example Lightweight Directory Access Protocol (LDAPO, Radius, or Windows NT/2000 domain.

c) Distribution of user state updates

When a VPN node 12 goes online/offline, other nodes within the VPN are notified of this update such that the related security associations are also updated. Any further communication between VPN nodes is utilized through an IPSec protocol and does not flow through the VPN server 44.

d) Providing a way to establish common secret

Each VPN node 12 generally possesses a common secret such as a private key which is passed to the IPSec layer and is used to protect the respective data traffic. This secret may be created by the VPN server 44 and distributed to the appropriate VPN node or the secret may be created locally at the node 12 and submitted to a second node in a secure and private manner through the VPN server 44. The common secret for example may be a symmetric key, “Internet key exchange” (IKE) so as to allow secured node-to-node communication.

e) Password exchange protocol

The system 50 encapsulates a secure-transaction mechanism to allow VPN nodes 12 to update their VPN passwords. After a node is successfully authenticated, the node is allowed to submit a password change request, followed by the approval/confirmation of both communication parties (VPN node and VPN server 44).

Although the invention has been described with reference to certain specific embodiments, various modifications thereof will be apparent to those skilled in the art without departing from the spirit and scope of the invention as outlined in the claims appended hereto.

1. A method for establishing a system for secure communications between nodes in a workgroup over a public network by facilitating the creation of a virtual private network (VPN), including a VPN server, the method comprising the steps of:
establishing a secure connection between at least a pair of nodes within said workgroup and said VPN server; and
synchronizing each of said connected nodes with said VPN server such that each of said connected nodes receives configurational information relating to attributes of each of said other connected nodes;
wherein, when an attribute relating to one of said connected nodes or said VPN server is revised, said configurational information relating to said attribute is updated at each of said connected nodes.

2. The method for establishing the system of claim 1, further comprising, following said step of establishing said secure connection, a step of authorizing, at said VPN server, validity of said connection between said VPN server and each of said connected nodes.

3. The method for establishing the system of claim 1, wherein following said step of synchronizing said server and each of said connected nodes, a step of sensing attribute revisions relating to one of said connected nodes or said server.

4. The method for establishing the system of claim 1, wherein said VPN server enables secure exchange of said configurational information between said connected nodes.

5. The method for establishing the system of claim 1, wherein said VPN server restricts exchanges of configurational information based on trust relationships established by said connected nodes.

6. The method for establishing the system of claim 1, wherein each of said connected nodes remains in a loop with said VPN server so as to forward any attribute revisions changes within a node to each of said connected nodes.

7. The method for establishing the system of claim 1, wherein each of said connected nodes automatically pull changes from said VPN server so as to update said configurational information stored at said node.

8. A system for establishing secure communication between nodes in a workgroup over a public network by facilitating the creation of a virtual private network, the system comprising:
at least a pair of nodes;
a VPN server, connected with each of said at least a pair of nodes for synchronizing each of said connected nodes with said VPN server such that each of said connected nodes receives configurational information relating to attributes of said other connected nodes or said VPN server;
wherein, when an attribute relating to one of said connected nodes or said server is revised, said configurational information relating to said attribute is updated at each of said connected nodes.

9. The system of claim 8, wherein said system further comprises a datastore connected to said server.

10. The system of claim 8, wherein said system further comprises a client application located at each of said connected nodes.

11. A method for establishing a system for secure transfer of a data packet between a first node and a second node in a workgroup over a public network, where said nodes are members of a virtual private network, the method comprising the steps of:
assessing a presence of a device associated with said connected first and second nodes;
modifying a packet header of said data packet intended for transfer between said first and second nodes when a device is detected;
wherein said modification of said packet headers facilitates traversing said detected device for transmission of said data packet between said first node and said second node.

12. The method for establishing the system of claim 11, wherein said modified packet header comprises an Encapsulated Security Payload (ESP) header, an Internet Protocol (IP) header, and a masquerade bit, said masquerade bit acting as an indicator to one of said first and second nodes that said data packet has been modified.

13. The method for establishing the system of claim 12, wherein said masquerade bit is located between said ESP header and said IP header.

14. The method for establishing the system of claim 12, wherein a packet interception mechanism analyses said packet headers for detecting the presence of said masquerade bit.

15. The method for establishing the system of claim 13, wherein when said masquerade bit is detected within said packet header, said modified packet header is removed and the original packet header of said data packet routes said data packet to one of said first and second node.

16. The method for establishing the system of claim 11, wherein said device is selected from a group comprising a Network Address Translation (NAT) Device, a firewall, a gateway, a proxy server, and combinations thereof.

17. The method for establishing the system of claim 11, wherein when a device is detected, said device is located in front of said node.

18. A computer system for establishing the secure transfer of a data packet between nodes in a workgroup over a public network, where said nodes are members of a VPN, the system comprising:
a first node;
a second node;
a device detection mechanism; and
a packet interception mechanism;
wherein when a data packet is transferred from said first node to said second node and a device is detected at said second node, said data packet is intercepted and a packet header of said data packet is modified to facilitate the data transfer between said nodes.
